(19) United States
(12) Patent Application Publication
(10) Pub. No.: US 2017/0191445 A1
(43) Pub. Date: Jul. 6, 2017

(54) Multi-Layer Gasket Assembly

(71) Applicant: Federal-Mogul Corporation, Southfield, MI (US)

(72) Inventors: Benjamin Mahoney, Warren, MI (US); John Herald, Canton, MI (US); Daniel Vialard, Canton, MI (US)

(21) Appl. No.: 14/988,228

(22) Filed: Jan. 5, 2016

(51) Int. Cl. F02F 11/00; F16J 15/10

(52) U.S. Cl. CPC F02F 11/002; F16J 15/104

(57) ABSTRACT

The multi-layer gasket assembly includes a plurality of gasket layers which present a plurality of co-axially aligned openings and have outer peripheries. At least two of the gasket layers are functional layers and have full embossment beads which are spaced from and surround the openings. The functional layers further include half beads with are spaced from the full embossment beads. One or more of the gasket layers presents a redundant seal spaced from the full and half embossment beads of the functional layers and located adjacent the outer peripheries of the one or more gaskets. The redundant seal has a height which is less than a height of the half beads of the functional layers. The redundant seal restricts any fluids that have wicked past the full embossment beads and the half beads from escaping out of the internal combustion engine.

### BACKGROUND OF THE INVENTION

1. Technical Field

This invention relates generally gasket assemblies for establishing fluid tight seals between two members to be clamped together and, more particularly, to multi-layer gasket assemblies, such as cylinder head gaskets.

2. Related Art

In establishing a gas and fluid-tight seal between two members to be clamped together, such as a cylinder head and an engine block, it is common to use a static cylinder head gasket which has multiple layers. Generally, at least one of the layers is a functional layer which has a full embossment bead bead for establishing the gas and fluid tight seal. Another of the layers is typically a distance layer for compressing the seal bead of the functional layer. In some cases, the functional layer also has a single half bead which is spaced radially from the full embossment bead.

### SUMMARY OF THE INVENTION AND ADVANTAGES

One aspect of the present invention provides for a multi-layer gasket assembly for establishing a gas and fluid tight seal between two members to be clamped. The gasket assembly includes a plurality of gasket layers which present a plurality of co-axially aligned openings and have outer peripheries. At least two of the gasket layers are functional layers and have full embossment beads which are spaced from and surround the openings. The functional layers further include half beads with are spaced from the full embossment beads on an opposite side of the full embossment beads from the openings. One or more of the gasket layers presents a redundant seal spaced from the full and half embossment beads of the functional layers and located adjacent the outer peripheries of the one or more gaskets. The redundant seal has a height which is less than a height of the half beads of the functional layers. The redundant seal is advantageous because it restricts the passage of any fluids that may have wicked past the full embossment beads and the half beads out of the internal combustion engine without compromising the seals established by the full and half beads.

According to another aspect of the present invention, the redundant seal is an additional half bead formed into at least one of the functional layers.

According to yet another aspect of the present invention, both of the functional layers have redundant seals in the form of additional half beads.

According to still another aspect of the present invention, the half beads on the functional layers extend in opposite directions from one another.

According to yet a further aspect of the present invention, at least one of the gasket layers is a distance layer sandwiched between the functional layers.

According to still a further aspect of the present invention, the redundant seal is a rubber bead on the distance layer.

According to another aspect of the present invention, the outer periphery of the distance layer extends past the outer peripheries of the functional layers.

According to yet another aspect of the present invention, the outer peripheries of the gasket layers are all aligned with one another.

According to still another aspect of the present invention, the gasket assembly further includes a stopper on one of the gasket layers for restricting full flattening of the full embossment beads.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is a top elevation view of a first exemplary embodiment of a multilayer gasket assembly constructed according to one aspect of the present invention

FIG. 2 is a cross-sectional view of the first exemplary embodiment of the multilayer gasket assembly taken through Line 2-2 of FIG. 1;

FIG. 3 s a cross-sectional view of the multi-layer gasket of FIG. 1 installed between a cylinder head and an engine block of an internal combustion engine;

FIG. 4 is another cross-sectional view of the multi-layer gasket assembly of FIG. 1 installed between a cylinder head and an engine block of an internal combustion engine and showing the cylinder head lifting away from the engine block during combustion in a cylinder bore;

FIG. 5 is a cross-sectional view of a second exemplary embodiment of the multi-layer gasket assembly;

FIG. 6 is a cross-section of a third exemplary embodiment of the multi-layer gasket assembly;

FIG. 7 is a cross-sectional view of a fourth exemplary embodiment of the multi-layer gasket assembly;

FIG. 8 is a cross-sectional view of a fifth exemplary embodiment of the multi-layer gasket assembly; and

FIG. 9 is a cross-sectional view of a sixth exemplary embodiment of the multi-layer gasket assembly.

### DETAILED DESCRIPTION OF PRESENTLY PREFERRED EMBODIMENTS

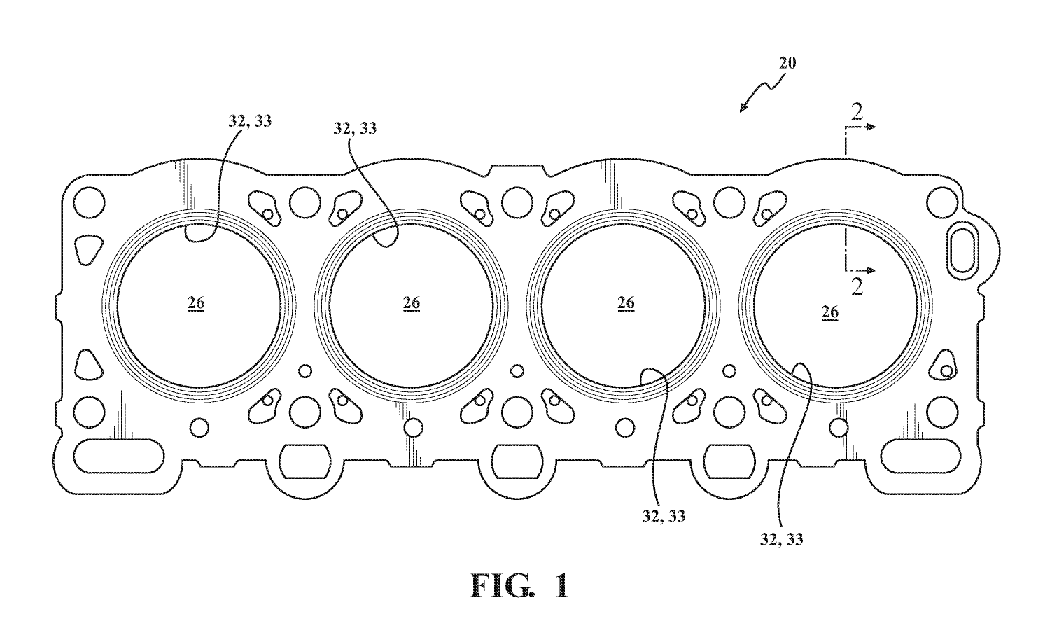

Referring to the Figures, wherein like numerals indicate corresponding parts throughout the several views, a first exemplary embodiment of a multi-layer gasket assembly 20 is generally shown in FIGS. 1-3. In the exemplary embodiment, the gasket assembly 20 is a cylinder head gasket which is adapted to establish a gas and fluid tight seal around a plurality of cylinder bores and between an engine block 22 and a cylinder head 24 of an internal combustion engine. However, it should be appreciated that the gasket assembly 20 could find uses in a range of sealing applications.

As shown in FIG. 1, the gasket assembly 20 includes plurality openings 26 that correspond with the cylinder bores in the engine block 22 (shown in FIG. 3). In the exemplary embodiment, the gasket assembly 20 has four openings 26 for sealing around the four cylinders of a four cylinder engine or for sealing around one bank of cylinders in a V-8 engine. However, it should be appreciated that the gasket assembly 20 could be configured to seal around any suitable number of cylinders depending on the design of the internal combustion engine. The gasket assembly 20 may also include a number of additional ports or openings for receiving bolts to attach the cylinder head 24 (shown in FIG. 3) to the engine block 22 (shown in FIG. 3) and for conveying fluid between the cylinder head 24 and the engine block 22.

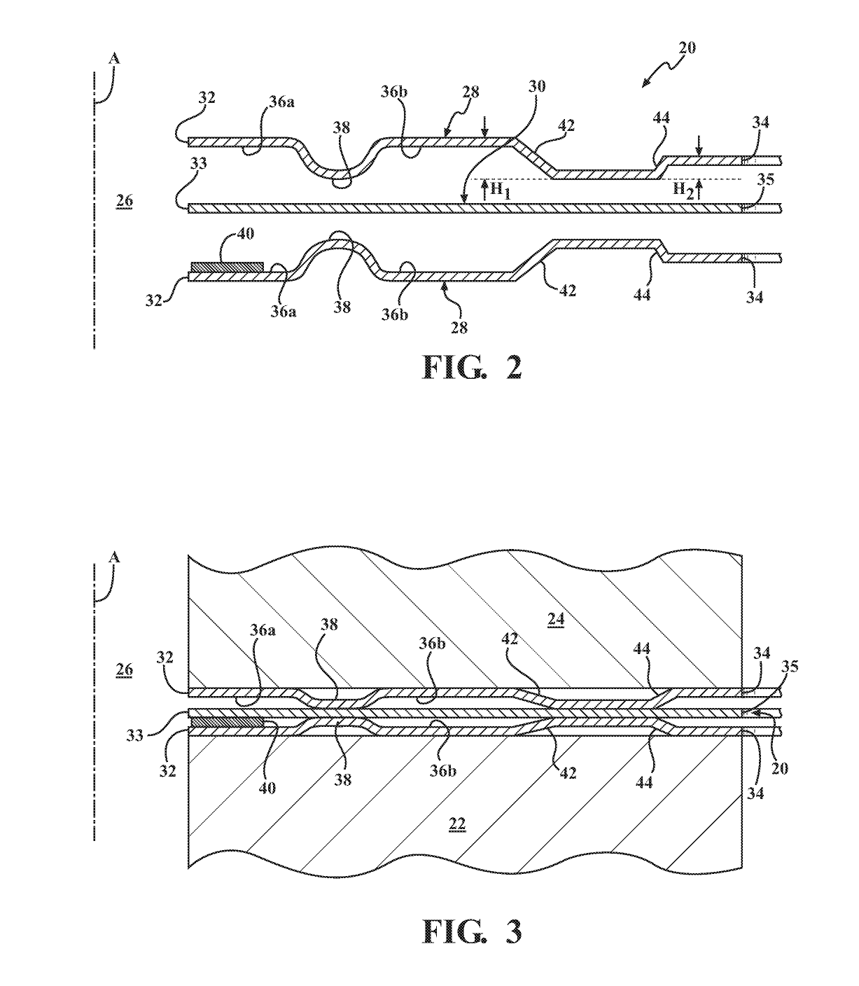

Referring now to FIG. 2, the gasket assembly 20 includes a plurality separately formed gasket layers 28, 30 which are in a stacked relationship with one another. The gasket layers 28, 30 all have inner peripheries 32, 33 which are radially aligned with one another to provide the gasket assembly 20 with the plurality of openings 26, i.e., the openings in the gasket layers 28, 30 are co-axially aligned with one another. Each of the gasket layers 28, 30 extends radially from its respective inner periphery 32, 33 to a respective outer periphery 34, 35. All of the gasket layers 28, 30 are preferably made of steel or a steel alloy. However, it should be appreciated that any suitable material may be employed.

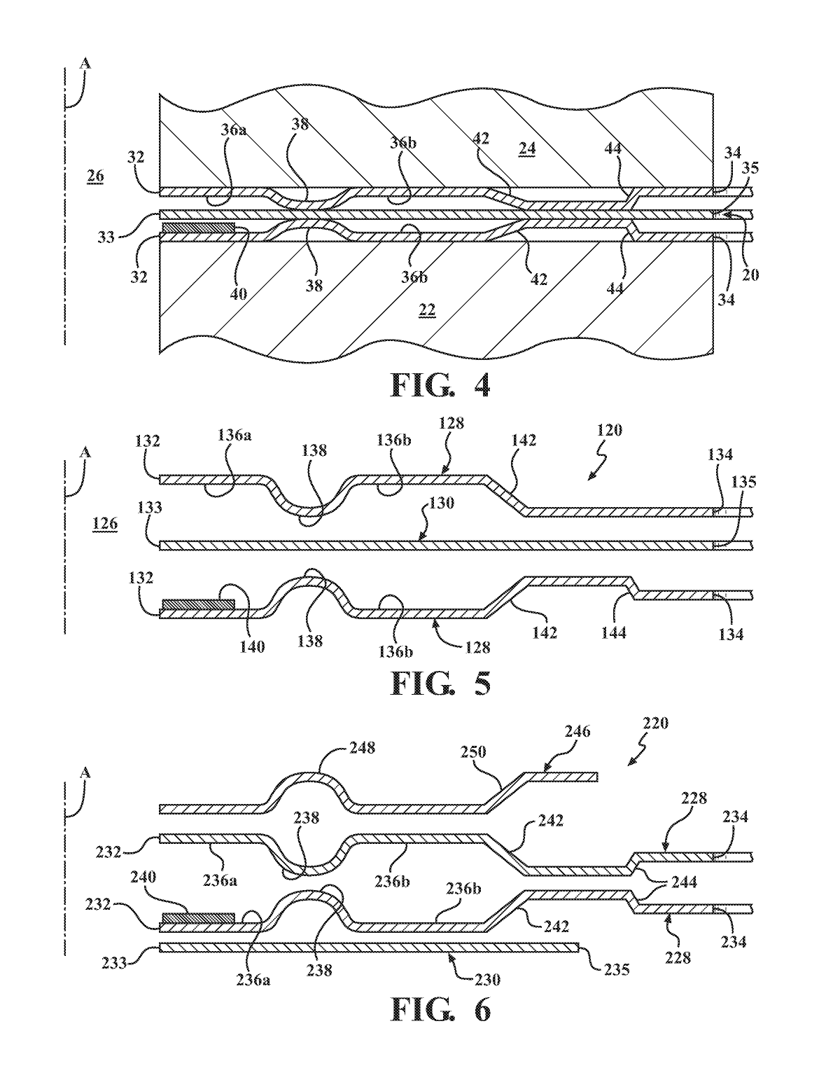

In the first exemplary embodiment, the plurality of gasket layers 28, 30 includes a pair of functional layers 28 which are shaped as mirror images of one another and a single distance layer 30 which is sandwiched between the functional layers 28. When in a relaxed, or unstressed, condition, each functional layer 28 has a pair of co-planar flat portions 36a, 36b on either radial side of a full embossment bead 38 which surrounds one of the openings 26. The functional layers 28 are oriented such that the full embossment beads 38 extend axially towards one another and press against the distance layer 30 when clamped between the cylinder head 24 and the engine block 22. One of the functional layers 28 includes a stopper 40 affixed thereto at one of the flat portions 36a between the inner periphery 32 and the full embossment bead 38 for preventing full flattening of at least one of the full embossment beads 38. During operation of the internal combustion engine, the full embossment beads 38 flex elastically as the cylinder head 24 lifts away from the engine block 22 in response to a gas and fuel combustion in the cylinder bore. This elastic flexing of the full embossment beads 38 maintains a primary gas and fluid-tight seal around the cylinder bore to prevent the combustion gasses and fluids from escaping the cylinder bore between the engine block 22 and cylinder head 24. FIG. 4 shows the state of the gasket assembly 20 with the cylinder head 24 lifting away from the engine block 22 during combustion in the respective cylinder bore and with the full embossment beads 38 flexing elastically to maintain the gas and fluid tight seal around the opening 26.

Spaced from the full embossment beads 38, each of the functional layers 28 further includes a half bead (referred to hereinafter as a “first half bead 42”) which provides a secondary seal around the opening 26. The first half beads 42 are spaced radially from the full embossment beads 38 on an opposite side of the full embossment beads 38 from the opening 26. In this exemplary embodiment, the first half beads 42 extend in an axial direction towards one another and press against the dynamic layer 30 when the gasket assembly 20 is clamped between the engine block 22 and the cylinder head 24.

In the first exemplary embodiment, the functional layers 28 each have redundant seals in the form of additional half beads 44 (hereinafter referred to as “second half beads”) which are spaced radially from the first half beads 42 and are located adjacent the outer peripheries 34 of the functional layers 28. The additional half beads 44 extend along the entire perimeters of the functional layers 28 to prevent any combustion gasses and fluids that have wicked past the full embossment beads 38 and the first half beads 42 from escaping out of the engine.

As shown in FIG. 2, when the gasket assembly 20 is in the resting condition, the first half beads 42 have a first height H₁ in the axial direction, and the second half beads 44 have a second height H₂ in the axial direction. The second height H₂ is less than the first height H₁ so that the loads applied by the second half beads 44 are less than the loads applied by the full embossment beads 38 and the first half beads 42. Because the loads of the second half beads 44 are reduced, the second half beads 44 do not compromise the seals established by the full embossment beads 38 and the first half beads 42.

Referring now to FIG. 5, a second exemplary embodiment of the multi-layer gasket assembly 120 is generally shown with like numerals, separated by a prefix of “1”, indicating corresponding parts with the first exemplary embodiment described above. The second exemplary embodiment is similar to the first exemplary embodiment but is distinguished therefrom by only one, not both, of the functional layers 128 having a redundant seal, i.e., an second half bead 144. In this exemplary embodiment, the functional layer 128 with the second half bead 144 is the same functional layer with the stopper 140 affixed thereto.

Referring now to FIGS. 6, a third exemplary embodiment of the multi-layer gasket assembly 220 is generally shown with like numerals, separated by a prefix of “2”, indicating corresponding parts with the first exemplary embodiment. The third exemplary embodiment is distinguished from the first exemplary embodiment in that the distance layer 230 is disposed at one axial side of the gasket assembly 220 as opposed to being sandwiched between the functional layers 228 as is the case in the first exemplary embodiment. As such, the functional layers 228 (or first and second functional layers) with the first half beads 242 and the redundant seals (second half beads 244) directly contact one another at the full embossment beads 238 and between the first half beads 242 and the second half beads 244. Additionally, the third exemplary embodiment of the gasket assembly 220 includes a third functional layer 246 opposite of the distance layer 230 and having a full embossment bead 248 and a first half bead 250 but no redundant seal. The full embossment bead 248 and first half bead 250 of the third functional layer 246 are radially aligned with the full embossment beads 238 and the first half beads 240 of the first and second functional layers 228 respectively.

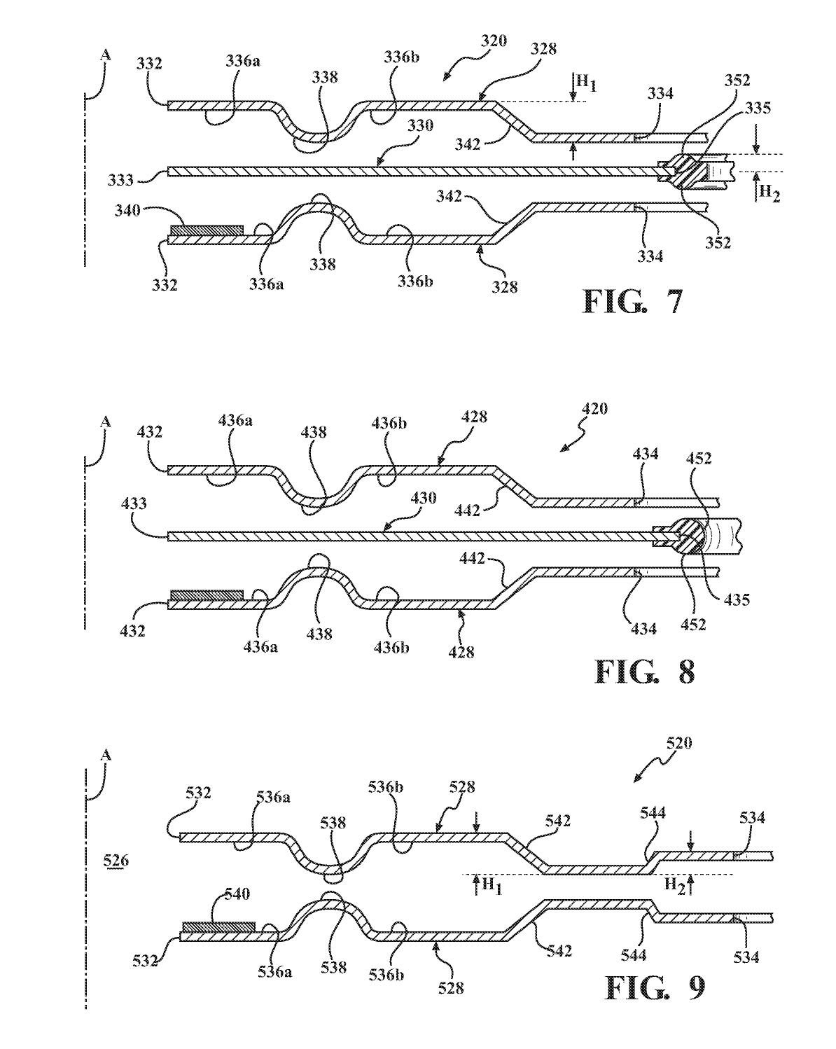

Referring now to FIG. 7, a fourth exemplary embodiment of the multi-layer gasket assembly 320 is generally shown with like numerals, separated by prefix of “3”, indicating corresponding parts with the first exemplary embodiment. The fourth exemplary embodiment is distinguished in that the redundant seal is provided on the distance layer 330 rather than the functional layers 328. Specifically, the distance layer 330 extends radially past the outer peripheries 334 of the functional layers 328, and the redundant seals are a pair of elastomeric beads 352 which are molded onto the outer periphery 335 of the distance layer 330 and extend on either axial side of the distance layer 330. The exemplary elastomeric beads 352 are integrally connected with one another around the outer periphery 335 of the distance layer 330. Each of the elastomeric beads 352 has a second height H₂ which is less than the first height H₁ of the first half beads 342. As such, the loads applied by the elastomeric beads 352 do not compromise the seals established by the full embossment beads 338 and the first half beads 342. The elastomeric beads 352 are preferably made of a rubber material and are engaged with the distance layer 330 through an overmolding process.

Referring now to FIG. 8, a fifth exemplary embodiment of the of the multi-layer gasket assembly 420 is generally shown with like numerals, separated by a prefix of “4”, indicating corresponding parts with the fourth exemplary embodiment. The fifth exemplary embodiment is distinguished from the fourth exemplary embodiment in that the elastomeric beads 452 are disposed radially outwardly of the outer periphery 435 of the distance layer 430.

Referring now to FIG. 9, a fifth exemplary embodiment of the of the multi-layer gasket assembly 520 is generally shown with like numerals, separated by a prefix of “5”, indicating corresponding parts with the first exemplary embodiment. The fifth exemplary embodiment is distinguished from the first exemplary embodiment in that it does not include a distance layer.

Obviously, many modifications and variations of the present invention are possible in light of the above teachings. It is, therefore, to be understood that within the scope of the appended claims, the invention may be practiced otherwise than as specifically described.

What is claimed is:

1. A multi-layer gasket assembly for establishing a gas and fluid tight seal between two members to be clamped, comprising:
a plurality of gasket layers presenting a plurality of co-axially aligned openings and having outer peripheries;
at least two of said gasket layers being functional layers and having full embossment beads which are spaced from and surround said openings;
said functional layers further including half beads which are spaced from said full embossment beads on an opposite side of said full embossment beads from said openings;
one or more of said gasket layers presenting a redundant seal spaced from said full and half embossment beads of said functional layers and located adjacent said outer peripheries of said one or more gasket layers and wherein said redundant seal has a height that is less than a height of said half beads of said functional layers.

2. The multi-layer gasket assembly as set forth in claim 1 wherein said redundant seal is an additional half bead formed into at least one of said functional layers.

3. The multi-layer gasket assembly as set forth in claim 2 wherein each of said functional layers includes one of said redundant seals in the form of said additional half beads.

4. The multi-layer gasket assembly as set forth in claim 3 wherein said additional half beads on said functional layers extend in opposite directions from one another.

5. The multi-layer gasket assembly as set forth in claim 1 wherein at least one of said plurality of gasket layers is a distance layer sandwiched between said functional layers.

6. The multi-layer gasket assembly as set forth in claim 5 wherein said redundant seal is on said distance layer.

7. The multi-layer gasket assembly as set forth in claim 6 wherein said redundant seal is a rubber bead which is fixed with said distance layer.

8. The multi-layer gasket assembly as set forth in claim 6 wherein said outer periphery of said distance layer extends past said outer peripheries of said functional layers.

9. The multi-layer gasket assembly as set forth in claim 1 wherein said outer peripheries of said gasket layers are aligned with one another.

10. The multi-layer gasket assembly as set forth in claim 1 further including a stopper on at least one of said gasket layers for restricting full flattening of the full embossment beads.
